(19) United States
(12) Patent Application Publication
(10) Pub. No.: US 2026/0339767 A1
(43) Pub. Date: Oct. 29, 2026

(54) SYSTEMS AND METHODS FOR HOST SYSTEM STATUS INDICATION

(71) Applicant: Aivres Systems Inc., San Jose, CA (US)

(72) Inventor: Chun-Hung LIN, New Taipei City (TW)

(21) Appl. No.: 19/190,105

(22) Filed: Apr. 25, 2025

(51) Int. Cl. G06F 11/07; H04B 10/116

(52) U.S. Cl. CPC G06F 11/079; G06F 11/0709; H04B 10/116

(57) ABSTRACT

Methods, devices, and systems for indicating a status of a host system are provided. In one aspect, a host system includes: a host device that includes one or more processors; and a device controller. The device controller is configured to: receive information indicating at least one status of the host system and store the information; and encode the information into at least one data packet. The host system further includes a light controller and a light emitting device. The light emitting device is configured to emit a visible light beam. The light controller is configured to modulate, based on the at least one data packet, a current flowing through the light emitting device to modulate a characteristic of the visible light beam. The modulated characteristic of the visible light beam indicates the at least one status of the host system.

### TECHNICAL FIELD

The present disclosure is related to a host system.

### BACKGROUND

Computing devices, such as servers, are widely used in a variety of fields. In areas such as artificial intelligence (AI) and big data, the need for computing is growing rapidly. To improve flexibility and computational efficiencies, some computing devices are configured to include different external devices within the same server chassis, making the computing devices suitable for a variety of applications. Some computing devices use a Peripheral Component Interconnect Express (PCIe) bus to connect the external devices to processors on a motherboard.

### SUMMARY

The present disclosure describes systems and techniques for indicating a status of a host system using modulated visible light beam.

In some implementations, a host system includes: a host device that includes one or more processors; and a device controller. The device controller is configured to: receive information indicating at least one status of the host system and store the information; and encode the information into at least one data packet. The host system further includes a light controller and a light emitting device. The light emitting device is configured to emit a visible light beam. The light controller is configured to modulate, based on the at least one data packet, a current flowing through the light emitting device to modulate a characteristic of the visible light beam. The modulated characteristic of the visible light beam indicates the at least one status of the host system.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following benefits, effect and/or advantages. For example, the techniques described in the present disclosure enables a status (e.g., a fault status) of a host system to be indicated using modulated visible light beam without the need for large liquid crystal display (LCD) screens, thereby saving space on a front panel of the host system. For example, the host system can encode the information regarding a fault status of the host system into a visible light beam by modulating the flashing frequency and/or intensity of the light beam. The modulated light beam can be emitted by a light emitting device (e.g., a light emitting diode (LED)) of the host system, and then received by a user device (e.g., phone) for demodulation. After demodulation, the status information of the host system can be determined and displayed on a screen of the user device. As the modulated light beam can be emitted using small-sized LEDs, a large LCD screen on the host system is not necessary for alerting the fault status. Therefore, the host system can have a more compact configuration. Additionally, the techniques can reduce power consumption by using small-sized LEDs compared to a large screen.

In addition, the techniques enable more detailed information to be transmitted via modulated visible light beam. For example, modulated visible light beam can have a higher data transfer rate as it may be modulated rapidly, allowing more bits to be transmitted per minute.

Further, the techniques allow for more stable transmission of the host system status information with less interference from other radio-frequency (RF) based devices. For example, the visible light beam has a wavelength in the range of 380-750 nm, corresponding to frequencies around 400-790 THz. This frequency range is separated from Wi-Fi or Bluetooth operation spectrum (e.g., 2.4-5 GHz) that may be used by other RF based devices. Therefore, the transmission of the host system status information using modulated visible light beam can be stable.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram of an example of a host system.

FIG. 2 illustrates a system diagram of an example of the host system and an example of a user device for visible light communication.

FIG. 3 illustrates an example of a data packet that carries information of host system status.

FIG. 4 illustrates an example diagram of time-series of bits based on Recommended Standard (RS) 232.

FIG. 5 illustrates an example of a library for translating between binary codes and host system statuses.

FIG. 6 illustrates a flow chart of an example of a method of indicating a status of a host system using modulated visible light beam.

FIG. 7 is a block diagram illustrating an example architecture of a computing system.

FIG. 8 is a block diagram illustrating an example architecture of a computing device.

Like reference numbers and designations in the various drawings indicate like elements. It is to be understood that the various exemplary implementations shown in the figures are merely illustrative representations and are not necessarily drawn to scale.

### DETAILED DESCRIPTION

The present disclosure describes a host system that uses modulated visible light beam to alert a user of its operation status (e.g., a fault status). The host system can be a computing system (e.g., a server) or a computing device (e.g., a computer). The host system can detect a fault status and encode fault status information into a visible light beam by modulating the flashing frequency and/or intensity of the light beam. The modulated visible light beam can be emitted by a light emitting device (e.g., a LED) of the host system, and then received by a user device (e.g., a cell phone) for demodulation. Once demodulated, the fault status information can be displayed on a screen of the user device, alerting the user of the fault status and prompting the user to take appropriate actions.

The following detailed description describes systems and techniques for a host system configured to indicate its operation status using visible light communication (VLC), and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

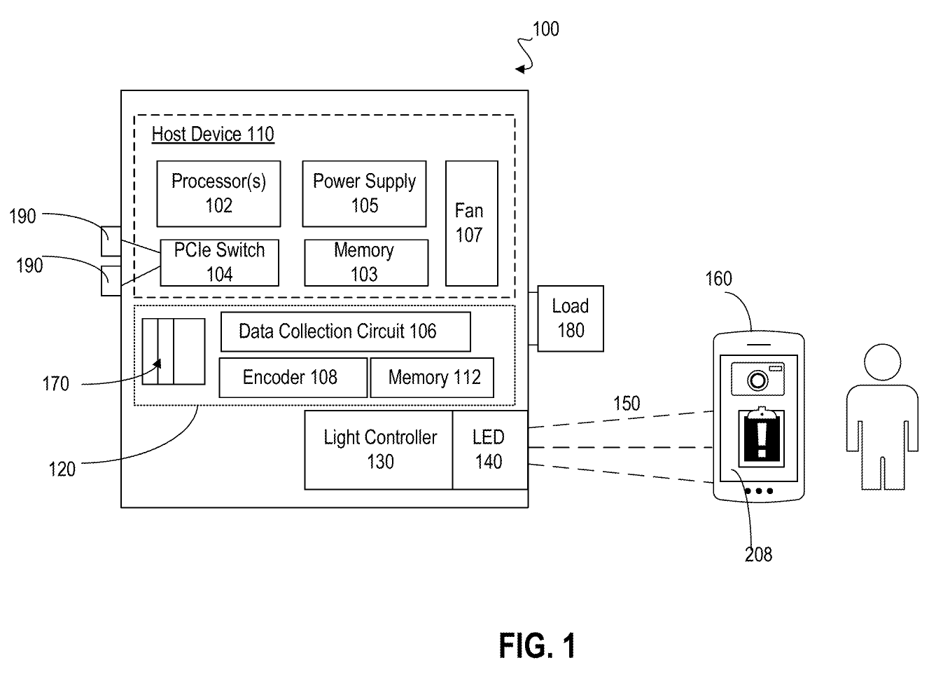

FIG. 1 illustrates a block diagram of a host system 100. The host system 100 can be a computing system (such as a server) or a computing device (such as a computer). The host system 100 can be configured to support general computation tasks, high-performance computing (HPC) applications, deep learning applications, artificial intelligence (AI), and/or high storage capacity. The host system 100 includes one or more processors 102. The one or more processors 102 can include, e.g., one or more central processing units (CPUs), one or more graphics processing units (GPUs), one or more data processing units (DPUs), one or more Application Specific Integrated Circuits (ASICs), one or more Field Programmable Gate Arrays (FPGAs), one or more multi-core processors, one or more microprocessors, one or more quantum processors, or a combination thereof.

The host system 100 can include one or more memories 103, such as volatile memory (e.g., RAM) for temporary data storage and non-volatile memory (e.g., flash storage, NAND, ferroelectric memory devices, magneto-resistive memory devices, or hard drives) for long term data retention. The memory 103 can store various types of information, e.g., system configurations, fault status logs, user settings, and application data.

The host system 100 can include a Peripheral Component Interconnect Express (PCIe) switch 104 to connect the external devices to processors. In some examples, the PCIe switch 104 can act as a hub, enabling communication between multiple PCIe devices 190 (like graphics processing unit (GPUs), storage devices, and network cards) and the processors 102. The PCIe switch 104 can manage data transfer and reduce latency by managing the distribution of PCIe lanes.

The host system 100 can additionally include a power supply unit 105 (e.g., a multi- phase voltage regulator) configured to supply power to at least the processors 102, and a fan 107 configured to cool and maintain a temperature of the host system 100 within an acceptable range. A combination of the components described above can be referred to as a host device 110 in the present disclosure.

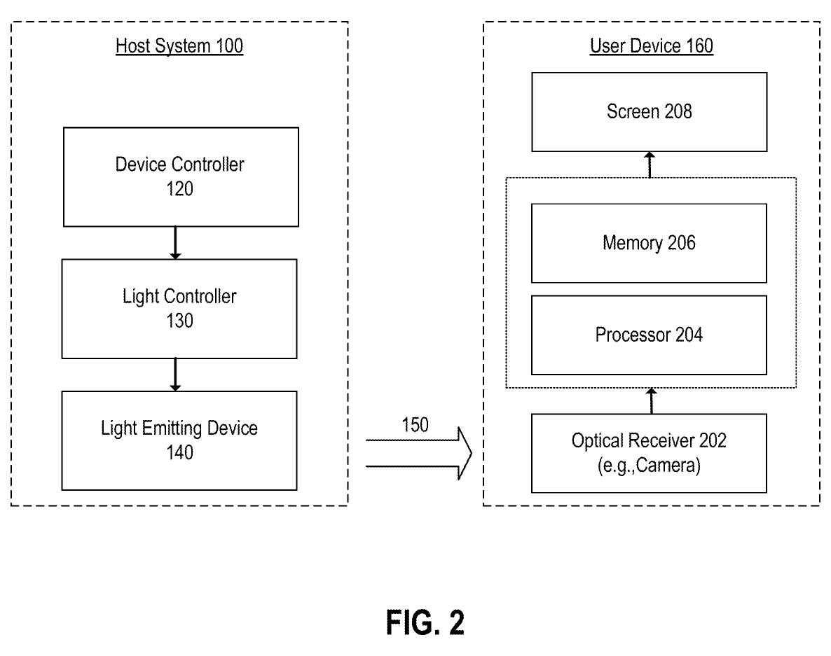

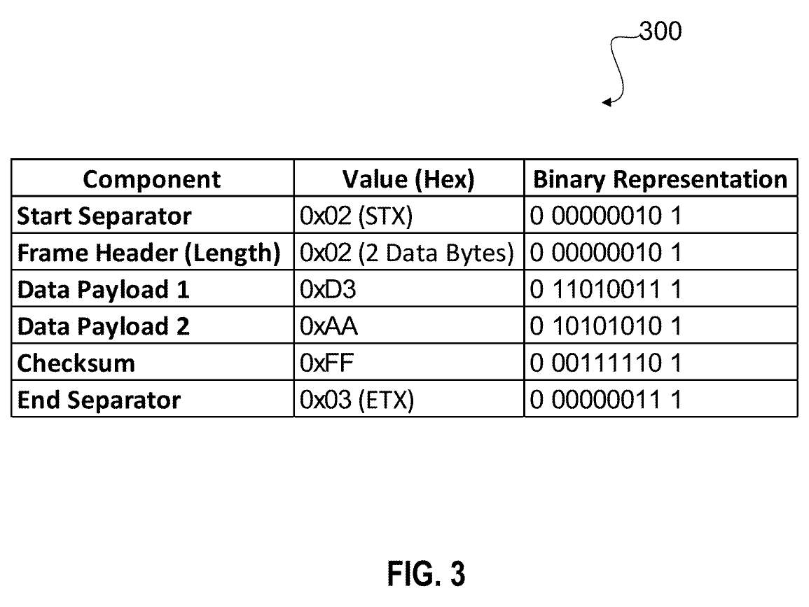

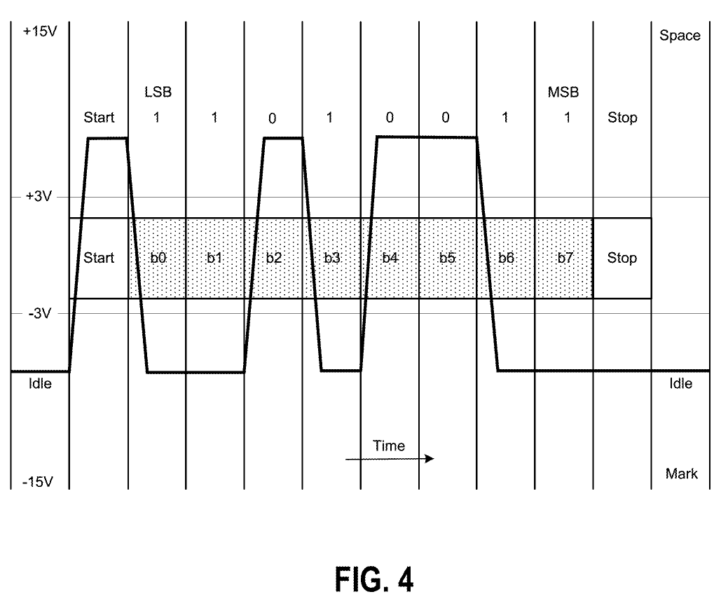

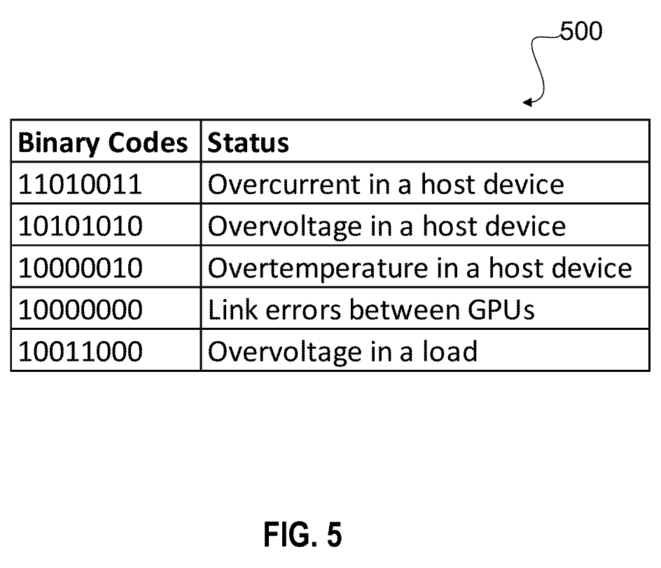

In some implementations, the host system 100 is configured to indicate its operation status (e.g., a fault status) using modulated visible light beam. The host system 100 can include a device controller 120, a light controller 130 and at least one light emitting device 140. The device controller 120 can receive information indicating at least one status of a host system 100, store the information, encode the information into at least one data packet, and transmit the data packet to the light controller 130. The light controller 130 can modulate a current flowing through a light emitting device 140. The light emitting device 140 can then emit, based on the modulating current, a modulated visible light beam 150 that is encoded with the status information of the host system 100. The modulated visible light beam 150 can be received by a user device 160 (e.g., a phone) for demodulation to determine the status of the host system 100. The status of the host system 100 may be displayed on the screen of the user device 160. Each component is described in greater details below in reference to FIGS. 1-5. Specifically, FIG. 2 illustrates a system diagram of an example of a host system and an example of a user device for visible light communication. FIG. 3 illustrates an example of a data packet that carries information of host system status. FIG. 4 illustrates an example diagram of time-series of bits based on Recommended Standard (RS) 232. FIG. 5 illustrates an example of a library for translating between binary codes and host system statuses.

Referring to FIGS. 1 and 2, in some implementations, the device controller 120 is a baseboard management controller (BMC) configured to monitor various system health parameters, e.g., temperature, fan speeds, power supply voltages, CPU usage, or memory health. In some examples, the device controller 120 can include a microcontroller and one or more sensors 170. The one or more sensors 170 can include, without limitation to, (i) a temperature sensor configured to monitor the temperature of the one or more processors 102 (e.g., CPU), PCIe devices 190, and/or other components in the host system 100, (ii) a voltage sensor configured to monitor power supply levels, (iii) a fan sensor configured to monitor fan speed and airflow; (iv) a memory fault sensor configured to detect faults in memory devices or memory controllers, and/or (v) a power sensor configured to monitor the health of the power supply (e.g., whether the power levels are within the required range).

The device controller 120 can be coupled to the one or more processors 102. The device controller 120 can be configured to communicate with the processors 102 through inter-integrated circuit (I²C) communication protocol.

In some implementations, the device controller 120 is configured to receive information indicating at least one status of the host system 100. In some implementations, status of the host system 100 includes at least one fault status of the host system 100. The fault status of the host system 100 can include at least one of an overtemperature level, an overvoltage level, an overcurrent level, an error of the one or more processors 102, an error of the PCIe device 190 (e.g., GPUs), an error associated with an external device (e.g., the load 180) coupled to the host device, a fault event log, an error associated with a hard disk drive (e.g., the memory 103, 112), an error associated with a power supply unit 105, or an error associated with a fan 107. In some implementations, status of the host system 100 includes at least one normal operational status of the host system 100. For example, the status of the host system 100 can include an operation log, a load being plugged in, the host system 100 operating normally, a voltage being within an acceptable range, or a current being within an acceptable range. It is to be noted that the status of the host system 100 is not limited to the examples described herein. Other status of the host system 100 are also possible.

In some implementations, the device controller 120 is configured to receive the information indicating the status of the host system 100 (e.g., overvoltage value, overcurrent value, or overtemperature value) from the sensors 170. In some implementations, the device controller 120 is configured to receive the information (e.g., cache errors, overheating, overclocking failures) from one or more processors 102, e.g., through I²C communication protocol. In some implementations, the device controller 120 is configured to receive the information (e.g., fault status log or normal operation status log) from the memory 103. In some implementations, the device controller 120 is configured to receive the information (e.g., link errors between PCIe devices 190) from the PCIe switch 104.

In some implementations, the device controller 120 is configured to periodically (e.g., every 1 second, 5 seconds, 60 seconds, 3 minutes, 10 minutes, or 30 minutes) receive the information. In some implementations, the device controller 120 is configured to receive the information in real-time, triggered by a fault event within the host system 100. For example, if a fault condition is detected by the host system 100, the device controller 120 can receive and process the fault information without waiting for next periodic update cycle.

In some implementations, the device controller 120 is configured to store the information in a memory. Referring to FIG. 1, the memory can be the memory 103 of the host device 110 and/or the memory 112 of the device controller 120. The memory 112 can be a non-volatile memory device (e.g., flash memory, hard disk drivers, solid state drivers, NAND devices, ferroelectric memory device, magneto-resistive memory device).

In some implementations, the device controller 120 is configured to encode the information indicating the at least one status of the host system 100 into at least one data packet. In some implementations, the data packet is based on a recommended standard (RS) 232 protocol or an inter-integrated circuit (I²C) communication protocol.

Referring now to FIG. 3, in some implementations, a data packet 300 includes at least one separator, a frame header and at least one data payload. The example data packet 300 in FIG. 3 includes a start separator, a frame header, two data payloads, a checksum, and an end separator. The start separator can indicate the beginning of the data packet 300. The frame header can include data indicating a packet length (e.g., how many bytes in the data payloads). The data payloads can include the actual data carrying the information of the status of the host system 100. The checksum can be used for error detection, e.g., by verifying the received data matches the transmitted data. The end separator can indicate the end of the data packet. The separators, the frame header, the data payloads, and the checksum can be referred to as data components in the present disclosure.

In the example data packet 300 shown in FIG. 3, each data component can include 10 binary bits, as shown in the last column of FIG. 3. The total length for the data packet 300 can then be 60 bits (e.g., 6 data components with each having 10 bits). In some implementations, each data component can have a RS232 frame structure. Referring now to FIG. 4, which shows a RS232 voltage levels for data payload 1 of FIG. 3, a RS232 frame structure can include a start bit, followed by 8 data bits and finally a stop bit, totaling 10 bits. The start bit can signal the beginning of the data transmission of a data component. The 8 data bits can encode information. The stop bit can signal the end of the data transmission of the data component. In some implementations, each RS232 frame structure can include a parity bit (for error checking) between the data bits and stop bit. In some implementations, the start bit of the RS232 frame structure has a logic zero or LOW (e.g., in a voltage range of +3 to +15 volts), and the stop bit of the RS232 has a logic 1 or HIGH (e.g., in a voltage range -3 to -15 volts).

Returning to FIG. 3, the last column of FIG. 3 shows framed data component based on RS232, each with a start bit “0” and a stop bit “1.” The middle bits are actual data that carry information. For example, the middle 8 binary bits of the frame header can indicate the length of the data packet 300, for example, 00000010 (e.g., number 2 in decimal) indicates that two bytes (e.g., 16 bits) are included in the data payloads of the data packet 300. In another example, data payload 1 can include 1 byte of actual information (e.g., 11010011). Similarly, data payload 2 can include 1 byte of actual information (e.g., 10101010). The actual information stored in each data payload can also be referred to as a binary code in the present disclosure. Each binary code can correspond to a respective status of the host system 100. As a data packet can include one or more data payloads (e.g., two data payloads included in the example data packet 300), the data packet can include information indicative of one or more statuses of the host system 100.

A library can be used to translate between the binary code and corresponding host system status. Referring now to FIG. 5, the library 500 can include a plurality of binary codes and data indicating a plurality of statuses of the host system 100. Each of the plurality of statuses can correspond to a respective one of the plurality of binary codes. In the example library shown in FIG. 5, binary code 11010011 can indicate an overcurrent condition in a host device 110, 10101010 can indicate an overvoltage condition in a host device 110, 10000010 can indicate an overtemperature in a host device 110, 10000010 can indicate a link error between GPUs, while 10011000 can indicate an overvoltage condition in a load. Therefore, based on the library 500, data payload 1 of the data packet 300 can include the encoded data indicating an overcurrent condition in a host device 110, while data payload 2 of the data packet 300 can include the encoded data indicating an overvoltage condition in a host device 110.

In some implementations, the device controller 120 is configured to encode the information indicating the at least one status of the host system 100 into the at least one data packet 300 based on a library. In some implementations, the library can be a table (e.g., the library 500 of FIG. 5), a database, or another suitable data structure. In the implementation using a table, it can have, for example, a plurality of rows and columns where each row has at least a first column (e.g., the Binary Codes column of FIG. 5) to represent a binary code and a corresponding second column (e.g., the Status column of FIG. 5) to represent an associated status of the host system 100. The library 500 can be used, for example, to locate, select, or otherwise determine a row in a table that corresponds to the fault status of the host system 100 and to select, access, or otherwise obtain the corresponding binary code in an associated column of the row. For example, the device controller 120 can receive the information of the status of the host system 100 and compare it to each row in the table until it matches one of the items in the second column. From there, the binary code can be obtained by accessing an associated column of the selected row that has the matched status of the host system 100. Based on the obtained binary code, the device controller 120 can encode this binary code into a data packet (e.g., 300 of FIG. 3).

In some implementations, returning to FIG. 1, the host system 100 is configured to store the library 500 in the memory 103 and/or the memory 112. In some implementations, the device controller 120 is configured to receive an erase request from an external device (e.g., the load 180) coupled to the host device 110; and erase, based on the erase request, the stored information. The load 180 can be a user device (e.g., 160 of FIG. 1) and include a memory that stores programming instructions for execution by the host system 100. The programming instructions can include the erase request of erasing all information or selected information regarding the status of the host system 100. The host system 100 can receive the erase request from the load 180, and erase the corresponding information in the memory 103 or 112.

In some situations, the device controller 120 may receive second information (e.g., new information) about the status of the host system 100 before a first information (e.g., a prior information) is erased. In some implementations, the device controller 120 is configured to store the second information in the memory, and modify, based on the second information, a first data packet that corresponds to the first information. The modified data packet can include binary codes corresponding to both the first and second information. For example, returning to FIGS. 3 and 5, the first information can be the overcurrent event in the host device 110, and the first data packet can include only data payload 1. When the second information (e.g., overvoltage in the host device 110) is received by the device controller 120, the device controller 120 can modify the first data packet to add data payload 2 after data payload 1. Additionally, the device controller 120 may also update the frame header to indicate that the length of the data packet (e.g., 300 of FIG. 3) has now increased to 2 and update the checksum value based on both data payloads. In some implementations, the device controller 120 is configured to transmit the modified data packet (e.g., 300 of FIG. 3) to the light controller 130 to emit a modulated visible light beam 150 indicating both the first and second information.

In some implementations, the device controller 120 includes a data collection circuit 106 and an encoder 108 coupled to the data collection circuit 106. The data collection circuit 106 can be configured to receive the information indicating at least one status of the host system 100, and the encoder 108 can be configured to encode the received information into the data packet 300, as described herein. In some examples, the data collection circuit 106 can include a first controller (e.g., programmable logic controller) with analog and digital inputs to read signals from sensors 170 and the host device 110. The encoder 108 can include a second controller with algorithm for encoding the information. Different controllers can communicate via protocols like inter-integrated circuit (I²C), serial peripheral interface (SPI), or universal asynchronous receiver-transmitter (UART). In some implementations, instead of having two separate controllers, the device controller 120 includes a single controller configured to perform both operations: receiving the information indicating at least one status of the host system 100 and then encoding the received information into the data packet 300. Communications within the device controller 120 can be based on analog or digital general purpose input/output (GPIO) pins.

It is to be noted that the example data packet 300 in FIG. 3 and the example library 500 in FIG. 5 are for illustration purpose and not intended to be construed in a limiting sense. Any other implementations of data packets and libraries can be employed. For example, while the data packet 300 has been described as having two data payloads, any other number of data payloads can be implemented. For example, each data packet can include 1, 3, 4, 5, 10, 15, or 20 data payloads.

While the data packet 300 has been described as having a start separator, a frame header, a checksum and an end separator, in some implementations, the data packet may not have one or more of these data components, or the data packet may include additional ones. For example, the data packet can include two frame headers (e.g., one indicating the number of bytes in data payloads, the other one indicating the data type). In another example, the data packet does not have a checksum.

While the binary code that encodes the host system status has been described as having 8 binary bits (e.g., 1 byte), any other number of binary bits can be implemented. For example, each binary code can include 1, 2, 3, 4, 5, 6, 7, 16 or 32 binary bits.

While each data component in the data packet 300 has been described as being framed based on RS232, in some implementations, the data packet 300 does not follow the RS232 frame format. Therefore, each data component in the data packet 300 can include only data bits without a start bit and a stop bit (e.g., 8 data bits in the example implementation of FIG. 3).

While the library 500 in FIG. 5 illustrates that each binary code is corresponding to a respective status of the system, in some implementations, one binary code may correspond to two or more statuses. For example, the binary code 11010011 can indicate there is overcurrent and overvoltage conditions in a host device 110. In some implementations, two or more binary codes may correspond to a single status of the host system 100. For example, both the binary code 11010011 1 and 10101010 can indicate an overcurrent condition of the host device 110.

Referring now to FIGS. 1 and 2, in some implementations, the light controller 130 is coupled to the device controller 120, and the light emitting device 140 is coupled to the light controller 130. The light emitting device 140 can be configured to emit a visible light beam (e.g., with a wavelength between 380 nm to 750 nm). In some implementations, the light emitting device 140 is a light emitting diode (LED), organic light emitting diodes (OLED), laser diode, red-green-blue (RGB) LED, or a quantum dot. In some implementations, an intensity of the visible light beam is based on an amplitude of a driving current supplied to the light emitting device 140 by the light controller 130. For example, a higher driving current amplitude can result in a stronger visible light beam.

In some implementations, the light controller 130 is configured to receive at least one data packet (e.g., 300 of FIG. 3) from the device controller 120. The light controller 130 can be configured to modulate, based on the at least one data packet, a current flowing through the light emitting device 140 to modulate a characteristic of the visible light beam. For example, the modulated current may have a higher amplitude representing a binary 1 in the data packet while a lower amplitude representing a binary 0. Therefore, with a sequence of 0s and 1s in data packet, the light controller 130 can generate a driving current that alternates between the higher amplitude and the lower amplitude in a regular or irregular pattern based on the data packet. The driving current can also be referred to as a modulated current in the present disclosure.

The modulated characteristic of the visible light beam can indicate the at least one status of the host system 100. In some implementations, the characteristic of the visible light beam includes at least one of a flashing frequency or a light intensity. As noted above, the light intensity of the visible light beam can be based on the amplitude of the driving current. Therefore, the light intensity can alternate between a high intensity value and a low intensity value in the same pattern as the amplitude of the driving current. In the example implementations where the binary codes are all 1s or all 0s, the visible light beam can have a constant intensity. In the example implementations where the data packet has a periodic and repeating 0-1 pattern (e.g., 10101010 or 11001100), the visible light beam intensity can alternate at a consistent rate and thus have a constant flashing frequency. In the example implementations where the data packet has an irregular pattern or non-repeating pattern, the visible light beam can have varying time intervals of high and low intensity states and thus have a variable flashing frequency.

In some implementations, the flashing frequency is in a range between 0 Hz and 60 Hz. In some implementations, the light intensity is modulated every second, with each binary bit in the data packet corresponding to the one second of light exposure. Therefore, the light intensity may update once per second for each bit. In the example implementation shown in FIG. 3 with 60 binary bits in the data packet 300, the entire data packet 300 can be encoded in the visible light beam over a total duration of 60 seconds.

In some implementations, the light controller 130 is configured to: based on the information stored in the device controller 120, control the light emitting device 140 to repeatedly emit the visible light beam with modulated characteristic. In the example implementation shown in FIG. 3, when the information is stored in the memory (e.g., 103 and/or 112 of FIG. 1), the light controller 130 can be configured to repeatedly emit the visible light beam every 60 seconds, transmitting the same 60-bit data packet during each 60-second interval. In other words, the visible light beam can have a repeated pattern every 60 seconds.

In some implementations, the light controller 130 is configured to, in response to determining that the information is erased, turn off the light emitting device 140. In some implementations, the device controller 120 is configured to send a termination signal to the light controller 130 indicating that the information has been erased, and the light controller 130 can then determine, based on the termination signal, that the information is erased. In some implementations, the device controller 120 is configured to periodically transmit the data packet to the light controller 130, with a transmission interval equal to or less than a duration of the visible light beam required to encode the entire data packet. For example, in the example described above, the transmission interval can be equal to or less than 60 seconds. In response to the information being erased, the device controller 120 can stop transmitting the data packet. If the light controller 130 fails to receive the data packet from the device controller 120, the light controller 130 can then power off the light emitting device 140.

While the modulated characteristics of the visible light beam have been described as including the flashing frequency and/or the light intensity, in some implementations, the modulated characteristics may alternatively or additionally include color (e.g., wavelength modulation), phase, polarization, and/or pulse width.

In some implementations, two or more light characteristics are combined to increase the capacity of the visible light communication. For example, both the color and intensity of the visible light beam can be modulated to transmit multiple channels of information in parallel (e.g., one channel for red, another for green). In the example implementations described above in reference to FIGS. 3 and 5, instead of transmitting in series the first information indicative of overcurrent in the host device 110 (e.g., data payload 1) and the second information indicative of overvoltage in the host device 110 (e.g., data payload 2) using a single light emitting device 140, the host system 100 can be configured to transmit, in parallel, the first information in red color using a first light emitting device and the second information in yellow color using a second light emitting device. As both the first information and the second information can be transmitted at the same time, the total duration of the light beam can be reduced. In another example, the red and/or yellow light can be used to transmit information about fault status of the host system 100, while a green light can be used to transmit a normal operation log of the host system 100.

Returning to FIG. 2, the modulated visible light beam 150 can be received by a user device 160 (e.g., a phone, a laptop, a tablet, or a computer). The user device 160 can include an optical receiver 202 (e.g., a camera) configured to receive the modulated visible light beam 150. In some implementations, the user device 160 includes at least one processor 204; and one or more memories 206 coupled to the at least one processor 204 and storing programming instructions for execution by the at least one processor 204 to perform operations. In some implementations, the operations include demodulating the modulated visible light beam 150 into at least one demodulated data packet. This demodulation process can be similar to the modulating process described above but performed in a reverse order. For example, the demodulation process can involve identifying the pattern of light intensity changes in the modulated visible light beam 150, and then generating a sequence of 0s and 1s, with 0 and 1 representing two different intensity levels, as described above.

In some implementations, the modulated data packet has the same data components as the data packet (e.g., 300 of FIG. 3) that is generated by the host system 100. For example, the modulated data packet can include a start separator, a frame header, one or more data payloads, a checksum, and an end separator, similar to those in FIG. 3.

In some implementations, the operations include determining one or more demodulated statuses of the host system 100 based on a library. The library can be stored in the memory 206 of the user device 160 and be the same as the library (e.g., 500 of FIG. 5) stored in host system 100. As described above, the library can be a table with a plurality of rows and columns, where each row has at least a first column (e.g., the Binary Codes column of FIG. 5) to represent a binary code and a corresponding second column (e.g., the Status column of FIG. 5) to represent an associated status of the host system 100. The demodulating operations can include extracting binary codes of data payloads from the demodulated data packet. Similar to the encoding techniques described above, decoding the status information can involve comparing each extracted binary code to the rows in the table until it matches one of the items in the first column. From there, the associated status of the host system 100 can be obtained by accessing an associated column of the selected row that has the matched binary code.

In some implementations, the operations further include displaying the demodulated status of the host system 100 in the user device 160 (e.g., on a screen 208, or a monitor). Therefore, the users can be notified of the status of the host system 100.

An example of a method of use is described herein. Referring to FIGS. 1 and 2, in operation, the users may notice the light emitting device 140 in the host system 100 is turned on, which signals that a status of the host system 100 is being transmitted through the light beam. The users may then stand in front of the light emitting device 140 and aim the camera on their device 160 (e.g., a phone) at the light beam to record it. The users may be instructed, e.g., based on a user manual for the host system 100, to record for at least a certain time period (e.g., 3 seconds, 5 seconds 30 seconds, 60 seconds, or 3 mins). Once the recording is complete, the user may run a pre-installed application on their phone (e.g., the instructions stored in the memory 206 of the user device 160 as described above) to analyze the recorded light beam. After the analysis is complete, the demodulated host system status can be displayed on the phone screen (e.g., 208 of FIGS. 1 and 2). If the recording duration was insufficient to capture the entire message, an error message may be displayed on the screen 208, instructing the user to record for a longer period.

After the user is informed of the host system status, the user may connect the phone (e.g., the load 180 in FIG. 1, the user device 160 of FIGS. 1 and 2) to the host device 110, e.g., by a universal serial bus (USB) cable. The phone may transmit an erase request (e.g., an instruction stored in the memory 206) to the device controller 120 to control the device controller 120 to erase the information stored in the host system 100. As noted above, after information is erased, the light emitting device 140 can be powered off. The user can then disconnect their phone from the host device 110. If the status of the host system 100 indicates a fault, the users may take appropriate measures to address this fault.

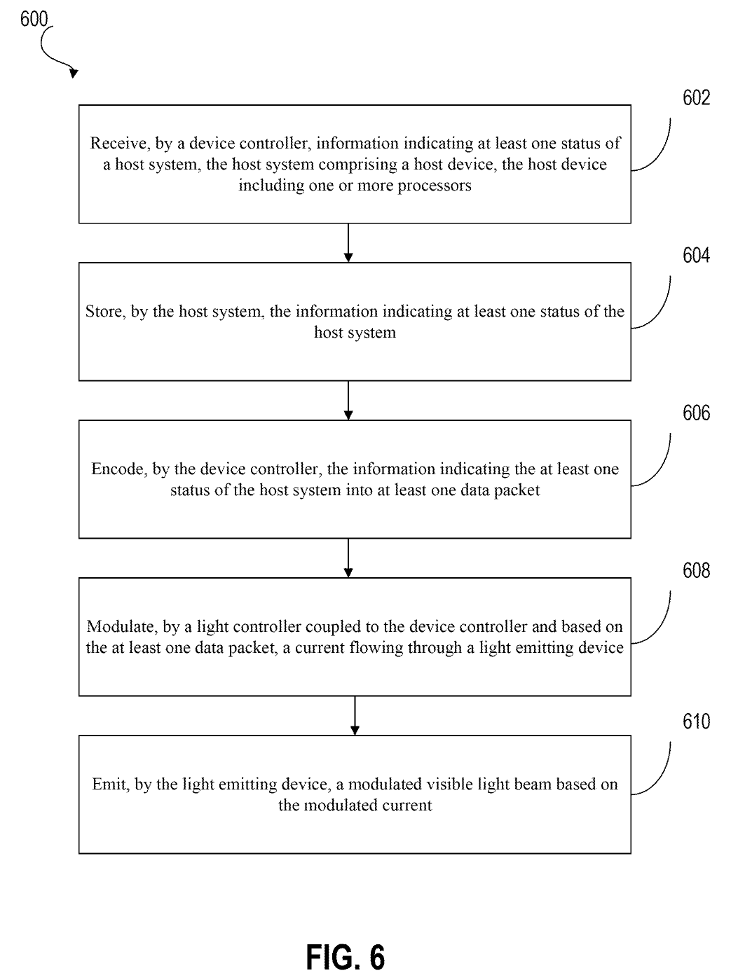

FIG. 6 illustrates a flow chart of an example of a method 600 of indicating a status of a host system using modulated visible light beam. The host system can be, e.g., the host system 100 of FIGS. 1 and 2.

At step 602, information indicating at least one status of a host system is received by a device controller. The host system includes a host device. The host device includes one or more processors. The device controller can be, e.g., the device controller 120 of FIGS. 1 and 2. The host device can be, e.g., the host device 110 of FIG. 1. The processors can be, e.g., the processors 102 of FIGS. 1 and 2.

At step 604, the information indicating at least one status of the host system is stored by the host system, e.g., in the memory 103 and/or memory 112 of the host system 100 of FIG. 1.

At step 606, the information indicating the at least one status of the host system is encoded by the device controller into at least one data packet, as described above in reference to FIGS. 1-5.

At step 608, a current flowing through a light emitting device is modulated by a light controller based on the at least one data packet. The light controller is coupled to the device controller. The light emitting device can be, e.g., the light emitting device 140 of FIGS. 1 and 2. The light controller can be, e.g., the light controller 130 of FIGS. 1 and 2.

At step 610, a modulated visible light beam based on the modulated current is emitted by the light emitting device.

In some implementations, the modulated visible light beam is configured to be demodulated into at least one demodulated data packet for determination of at least one demodulated status of the host system, and the at least one demodulated status of the host system is configured to be displayed, as described above in reference to FIGS. 1-5.

In some implementations, the information indicating the status of the host system includes at least one of an overtemperature level, an overvoltage level, an overcurrent level, an error of the one or more processors, an error of a peripheral component interconnect express (PCIe) device, an error associated with an external device coupled to the host device, a fault event log, an error associated with hard disk drive, an error associated with a power supply unit, or an error associated with a fan. The PCIe device can be, e.g., the PCIe device 190 of FIG. 1. The external device can be, e.g., the load 180 of FIG. 1, or the user device 160 of FIGS. 1 and 2. The hard disk drive can be, e.g., the PCIe device 190 of FIG. 1, the memory 103 of FIG. 1, or the memory 112 of FIG. 1. The power supply unit can be, e.g., the power supply unit 105 of FIG. 1. The fan can be, e.g., the fan 107 of FIG. 1, or the load 180 of FIG. 1.

In some implementations, the method 600 includes controlling the light emitting device to repeatedly emit the modulated visible light beam based on the information stored in the host system; receiving an erase request by the device controller from an external device that is configured to be coupled to the host device; erasing, based on the erase request, the stored information in the host system; and in response to determining that the information is erased from the device controller, turning off the light emitting device, as described above in reference to FIGS. 1-5.

In some implementations, emitting the modulated visible light beam includes: emitting the modulated visible light beam with a flashing frequency of a range between 0 Hz and 60 Hz.

In some implementations, receiving the information indicating at least one status of the host system includes: periodically receiving the information indicating the at least one status of the host system from at least one of: one or more sensors; the one or more processors; or a PCIe switch. The sensors can be, e.g., the sensors 170 of FIG. 1. The PCIe switch can be, e.g., the PCIe switch 104 of FIG. 1.

In some implementations, the method 600 includes transmitting, by the device controller, the at least one data packet to the light controller using at least one of a RS232 protocol or an inter-integrated circuit (I²C) communication protocol, as described above in reference to FIGS. 3-5.

In some implementations, each data packet of the at least one data packet includes at least one separator, a frame header, and at least one data payload, and where the frame header includes data indicating a packet length, as described above in reference to FIGS. 3-5.

In some implementations, each data packet of the at least one data packet corresponds to one or more statuses of the at least one status of the host system, as described above in reference to FIGS. 3-5.

In some implementations, the information indicating at least one status of the host system is first information, the at least one status is a first status, the modulated visible light beam is a first modulated visible light beam, where the method includes: receiving, by the device controller, second information indicating a second status of the host system; storing, by the device controller, the second information indicating the second status of the host system; modifying, by the device controller, the at least one data packet based on the second information; modifying, by the light controller, the modulated current based on the at least one modified data packet; and emitting, by the light emitting device, a second modulated visible light beam based on the modified modulated current, the second modulated visible light beam indicating both the first information and the second information, as described above in reference to FIGS. 1-5.

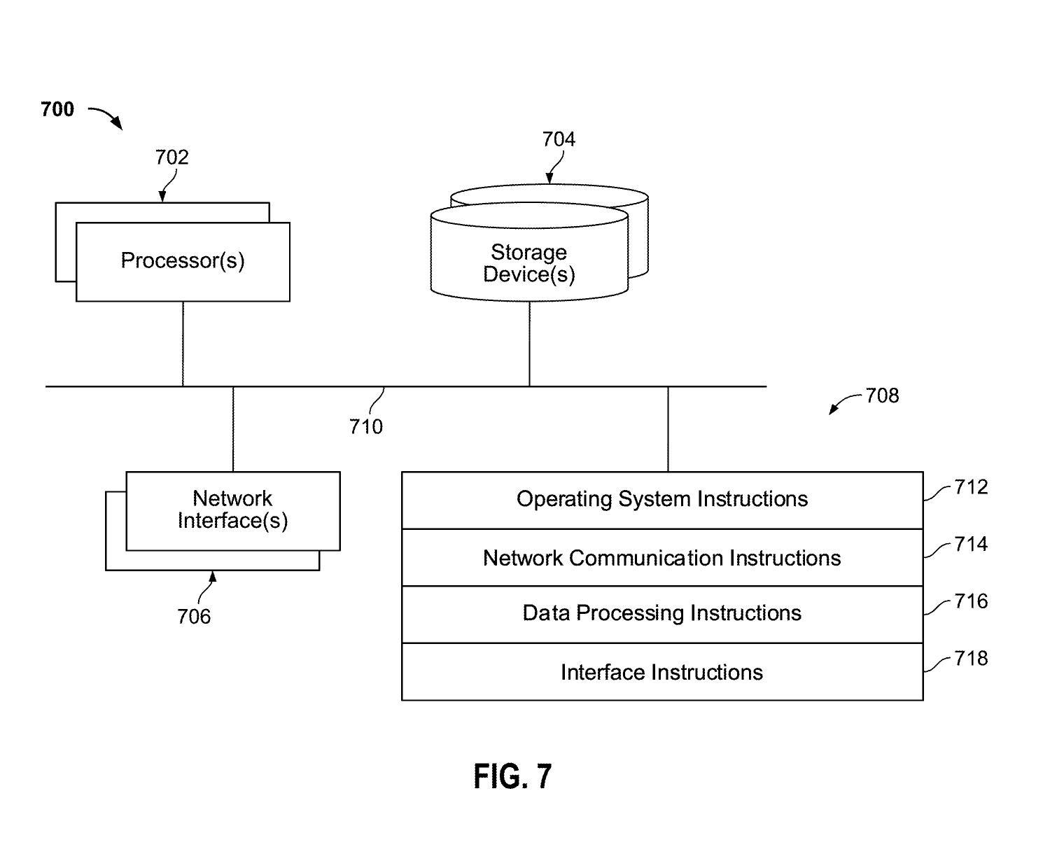

FIG. 7 is a block diagram illustrating an example architecture 700 of a computing system used to provide computational functionalities associated with described algorithms, methods, functions, processes, flows, and procedures. The computing system can be implemented as the host system 100 of FIGS. 1 and 2. Other architectures are possible, including architectures with more or fewer components.

In some implementations, architecture 700 includes one or more processor(s) 702 (e.g., dual-core Intel® Xeon® Processors), one or more network interface(s) 706, one or more storage device(s) 704 (e.g., hard disk, optical disk, flash memory) and one or more computer-readable medium(s) 708 (e.g., hard disk, optical disk, flash memory, etc.). These components can exchange communications and data over one or more communication channel(s) 710 (e.g., buses), which can utilize various hardware and software for facilitating the transfer of data and control signals between components.

The computing system can, for example, use a PCIe switch between the processors 702 and storage devices 704, where the processors 702 can be host devices and the storage devices can be PCIe devices. In some examples, the computing system can use a PCIe switch between processors 702, e.g., CPUs and GPUs, where the CPUs can be host devices and GPUs can be PCIe devices. In some other examples, the computing system can use a PCIe switch between processors 702 and network interfaces 706, where the processors can be host devices and the network interfaces 706 can be PCIe devices.

The term “computer-readable medium” refers to any medium that participates in providing instructions to the processor(s) 702 for execution, including without limitation, non-volatile media (e.g., optical or magnetic disks), volatile media (e.g., memory) and transmission media. Transmission media includes, without limitation, coaxial cables, copper wire, and fiber optics.

Computer-readable medium(s) 708 can further include instructions 712 for an operating system (e.g., Mac OS® server, Windows® NT server, Linux Server), instructions 714 for network communications module, data processing instructions 716, and interface instructions 718.

Operating systems can be multi-user, multiprocessing, multitasking, multithreading, real time, etc. Operating system performs basic tasks, including but not limited to: recognizing input from and providing output to devices 702, 704, 706 and 708; keeping track and managing files and directories on computer-readable medium(s) 708 (e.g., memory or a storage device); controlling peripheral devices; and managing traffic on the one or more communication channel(s) 710. Network communications module includes various components for establishing and maintaining network connections (e.g., software for implementing communication protocols, such as TCP/IP, HTTP, etc.) and for creating a distributed streaming platform using, for example, Apache Kafka™. Data processing instructions 716 include server-side or backend software for implementing the server-side operations. Interface instructions 718 includes software for implementing a web server and/or portal for sending and receiving data to and from user side computing devices and service side computing devices.

Architecture 700 can be implemented by a cloud computing system and can be included in any computer device, including one or more server computers in a local or distributed network each having one or more processing cores. Architecture 700 can be implemented in a parallel processing or peer-to-peer infrastructure or on a single device with one or more processors. Software can include multiple software components or can be a single body of code.

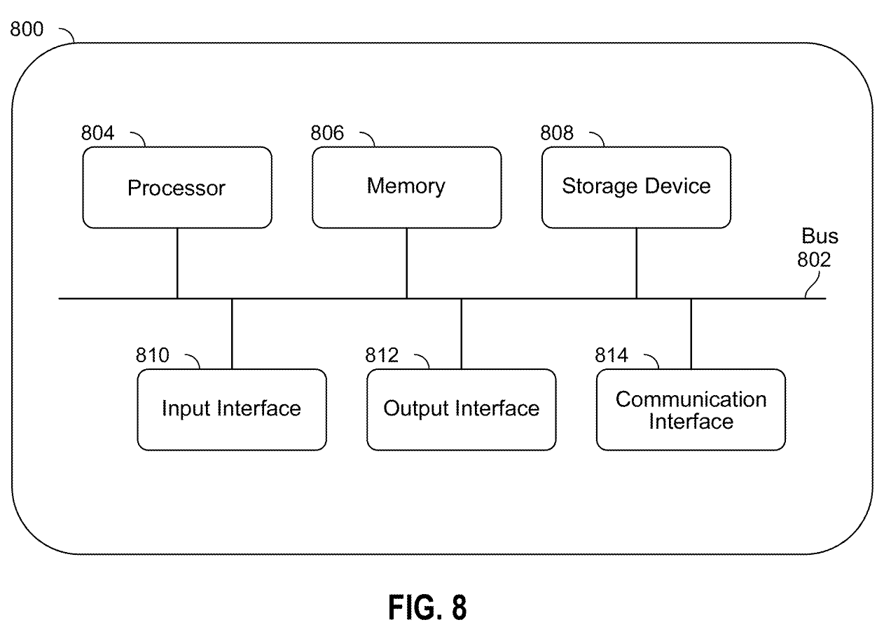

FIG. 8 is a block diagram illustrating an example architecture of a computing device 800 used to provide computational functionalities associated with described algorithms, methods, functions, processes, flows, and procedures. The computing device 800 can be implemented as the host system 100 of FIGS. 1 and 2. Other architectures are possible, including architectures with more or fewer components.

The computing device 800 includes processor 804, memory 806, storage component 808, input interface 810, output interface 812, communication interface 814, and bus 802. For example, the computing device 800 can use a PCIe switch between the processor 804 and the storage device 808 and/or the communication interface 814, where the processor 804 can be a host device and the storage component 808 and the communication interface 814 can be PCIe device(s).

Bus 802 includes a component that permits communication among the components of the computing device 800. In some embodiments, processor 804 is implemented in hardware, software, or a combination of hardware and software. In some examples, processor 804 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 806 includes random access memory (RAM), read-only memory (ROM), and/or another type of dynamic and/or static storage device (e.g., flash memory, magnetic memory, optical memory, and/or the like) that stores data and/or instructions for use by processor 804.

Storage component 808 stores data and/or software related to the operation and use of the computing device 800. In some examples, storage component 808 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 810 includes a component that permits the computing device 800 to receive information, such as via user input (e.g., a touchscreen display, a keyboard, a keypad, a mouse, a button, a switch, a microphone, a camera, and/or the like). Additionally or alternatively, in some embodiments, input interface 810 includes a sensor that senses information (e.g., a global positioning system (GPS) receiver, an accelerometer, a gyroscope, an actuator, and/or the like). Output interface 812 includes a component that provides output information from the computing device 800 (e.g., a display, a speaker, one or more light-emitting diodes (LEDs), and/or the like).

In some embodiments, communication interface 814 includes a transceiver-like component (e.g., a transceiver, a separate receiver and transmitter, and/or the like) that permits the computing device 800 to communicate with other devices via a wired connection, a wireless connection, or a combination of wired and wireless connections. In some examples, communication interface 814 permits the computing device 800 to receive information from another device and/or provide information to another device. In some examples, communication interface 814 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, the computing device 800 performs one or more processes described herein. The computing device 800 performs these processes based on processor 804 executing software instructions stored by a computer-readable medium, such as memory 806 and/or storage component 808. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 806 and/or storage component 808 from another computer-readable medium or another device via communication interface 814. When executed, software instructions stored in memory 806 and/or storage component 808 cause processor 804 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 806 and/or storage component 808 includes data storage or at least one data structure (e.g., a database and/or the like). The computing device 800 is capable of receiving information from, storing information in, communicating information to, or searching information stored in the data storage or the at least one data structure in memory 806 or storage component 808. In some examples, the information includes network data, input data, output data, or any combination thereof.

In some embodiments, the computing device 800 is configured to execute software instructions that are either stored in memory 806 and/or in the memory of another device (e.g., another device that is the same as or similar to the computing device 800). As used herein, the term “module” refers to at least one instruction stored in memory 806 and/or in the memory of another device that, when executed by processor 804 and/or by a processor of another device (e.g., another device that is the same as or similar to the computing device 800) cause the computing device 800 (e.g., at least one component of the computing device 800) to perform one or more processes described herein. In some embodiments, a module is implemented in software, firmware, hardware, and/or the like.

The number and arrangement of components illustrated in FIG. 8 are provided as an example. In some embodiments, the computing device 800 can include additional components, fewer components, different components, or differently arranged components than those illustrated in FIG. 8. Additionally or alternatively, a set of components (e.g., one or more components) of the computing device 800 can perform one or more functions described as being performed by another component or another set of components of the computing device 800.

Described implementations of the subject matter can include one or more features, alone or in combination.

For example, in a first implementation, a host system includes a host device including one or more processors; a device controller coupled to the one or more processors and configured to: receive information indicating at least one status of the host system and store the information; and encode the information indicating the at least one status of the host system into at least one data packet; a light controller coupled to the device controller; and a light emitting device coupled to the light controller and configured to emit a visible light beam, where the light controller is configured to modulate, based on the at least one data packet, a current flowing through the light emitting device to modulate a characteristic of the visible light beam, and the modulated characteristic of the visible light beam indicates the at least one status of the host system.

The foregoing and other described implementations can each, optionally, include one or more of the following features:

A first feature, combinable with any of the following features, where the at least one status of the host system includes at least one fault status of the host system.

A second feature, combinable with any of the previous or following features, where the information indicating the at least one status of the host system includes at least one of an overtemperature level, an overvoltage level, an overcurrent level, an error of the one or more processors, an error of a peripheral component interconnect express (PCIe) device, an error associated with an external device coupled to the host device, a fault event log, an error associated with a hard disk drive, an error associated with a power supply unit, or an error associated with a fan.

A third feature, combinable with any of the previous or following features, where the characteristic of the visible light beam includes at least one of a flashing frequency or a light intensity, and the flashing frequency is in a range between 0 Hz and 60 Hz.

A fourth feature, combinable with any of the previous or following features, where the device controller is configured to: receive an erase request from an external device coupled to the host device; and erase, based on the erase request, the stored information.

A fifth feature, combinable with any of the previous or following features, where the light controller is configured to: based on the information stored in the host system, control the light emitting device to repeatedly emit the visible light beam with modulated characteristic; and in response to determining that the information is erased, turn off the light emitting device.

A sixth feature, combinable with any of the previous or following features, where the light controller is configured to, based on the information stored in the host system, control the light emitting device to repeatedly emit the visible light beam with modulated characteristic.

A seventh feature, combinable with any of the previous or following features, where the device controller is configured to periodically receive the information indicating at least one status of the host system from at least one of: one or more sensors; the one or more processors; or a PCIe switch.

An eighth feature, combinable with any of the previous or following features, where each data packet of the at least one data packet includes at least one separator, a frame header and at least one data payload, and where the frame header includes data indicating a packet length.

A ninth feature, combinable with any of the previous or following features, where the device controller is configured to transmit, to the light controller, the at least one data packet using at least one of a recommended standard 232 protocol or an inter-integrated circuit (I²C) communication protocol.

A tenth feature, combinable with any of the previous or following features, where each data packet of the at least one data packet corresponds to one or more statuses of the at least one status of the host system.

An eleventh feature, combinable with any of the previous or following features, where the host system is configured to store a library, the library includes a plurality of binary codes and data indicating a plurality of statuses, and each of the plurality of statuses corresponds to a respective one of the plurality of binary codes, and where the device controller is configured to encode the information indicating the at least one status of the host system into the at least one data packet based on the library.

In a second implementation, a method includes receiving, by a device controller, information indicating at least one status of a host system, the host system including a host device, the host device including one or more processors; storing, by the device controller, the information indicating at least one status of the host system; encoding, by the device controller, the information indicating the at least one status of the host system into at least one data packet; modulating, by a light controller coupled to the device controller and based on the at least one data packet, a current flowing through a light emitting device; and emitting, by the light emitting device, a modulated visible light beam based on the modulating current.

The foregoing and other described implementations can each, optionally, include one or more of the following features:

A first feature, combinable with any of the following features, where the modulated visible light beam is configured to be demodulated into at least one demodulated data packet for determination of at least one demodulated status of the host system, and the at least one demodulated status of the host system is configured to be displayed.

A second feature, combinable with any of the previous or following features, where the information indicating the status of the host system includes at least one of an overtemperature level, an overvoltage level, an overcurrent level, an error of the one or more processors, an error of a peripheral component interconnect express (PCIe) device, an error associated with an external device coupled to the host device, a fault event log, an error associated with hard disk drive, an error associated with a power supply unit, or an error associated with a fan.

A third feature, combinable with any of the previous or following features, including: controlling the light emitting device to repeatedly emit the modulated visible light beam based on the information stored in the host system; receiving an erase request by the device controller from an external device that is configured to be coupled to the host device; erasing, based on the erase request, the stored information in the host system; and in response to determining that the information is erased from the device controller, turning off the light emitting device.

A fourth feature, combinable with any of the previous or following features, where emitting the modulated visible light beam includes: emitting the modulated visible light beam with a flashing frequency of a range between 0 Hz and 60 Hz.

A fifth feature, combinable with any of the previous or following features, where receiving the information indicating at least one status of the host system includes: periodically receiving the information indicating the at least one status of the host system from at least one of: one or more sensors; the one or more processors; or a PCIe switch.

A sixth feature, combinable with any of the previous or following features, including: transmitting, by the device controller, the at least one data packet to the light controller using at least one of a recommended standard 232 protocol or an inter-integrated circuit (I²C) communication protocol.

A seventh feature, combinable with any of the previous or following features, where each data packet of the at least one data packet includes at least one separator, a frame header, and at least one data payload, and where the frame header includes data indicating a packet length.

An eighth feature, combinable with any of the previous or following features, where each data packet of the at least one data packet corresponds to one or more statuses of the at least one status of the host system.

A ninth feature, combinable with any of the previous or following features, where the information indicating at least one status of the host system is first information, the at least one status is a first status, the modulated visible light beam is a first modulated visible light beam, where the method includes: receiving, by the device controller, second information indicating a second status of the host system; storing, by the device controller, the second information indicating the second status of the host system; modifying, by the device controller, the at least one data packet based on the second information; modifying, by the light controller, the modulated current based on the at least one modified data packet; and emitting, by the light emitting device, a second modulated visible light beam based on the modified modulated current, the second modulated visible light beam indicating both the first information and the second information.

In a third implementation, a device includes a device controller coupled to one or more processors, where the device controller includes: one or more sensors configured to measure one or more properties associated with a host system, where the host system includes a host device, and the host device includes one or more processors; and at least one circuit configured to: receive information indicating at least one status of the host system from at least one of (i) the one or more sensors, or (ii) the host device; and generate, based on the information indicating the at least one status of the host system, at least one data packet; a light controller coupled to the device controller; and a light emitting device coupled to the light controller, where the light controller is configured to modulate, based on the at least one data packet, a current flowing through the light emitting device to modulate a characteristic of a visible light beam, and the modulated characteristic of the visible light beam indicates the at least one status of the host system, and where the light emitting device is configured to emit the visible light beam with modulated characteristic.

The foregoing and other described implementations can each, optionally, include one or more of the following features:

A first feature, combinable with any of the following features, where the one or more sensors include at least one of: one or more temperature sensors; one or more voltage sensors; or one or more current sensors, and where the one or more properties associated with the host system include at least one of a temperature level, a voltage level, or a current level.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual’s action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors 102 or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

The term “and/or” can refer to and encompasses any and all possible combinations of one or more of the associated listed terms. For example, the term “A and/or B” means that either option A, option B, or both options A and B are possible, where A and B may be singular or plural.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensor 170y feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user’s mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 702.11x or other protocols, all or a portion of the Internet, another communication network, or a combination of communication networks. The communication network can communicate with, for example, internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A host system, comprising:
a host device comprising one or more processors;
a device controller coupled to the one or more processors and configured to:
receive information indicating at least one status of the host system and store the information; and
encode the information indicating the at least one status of the host system into at least one data packet;
a light controller coupled to the device controller; and
a light emitting device coupled to the light controller and configured to emit a visible light beam,
wherein the light controller is configured to modulate, based on the at least one data packet, a current flowing through the light emitting device to modulate a characteristic of the visible light beam, and the modulated characteristic of the visible light beam indicates the at least one status of the host system.

2. The host system of claim 1, wherein the at least one status of the host system comprises at least one fault status of the host system.

3. The host system of claim 1, wherein the information indicating the at least one status of the host system comprises at least one of an overtemperature level, an overvoltage level, an overcurrent level, an error of the one or more processors, an error of a peripheral component interconnect express (PCIe) device, an error associated with an external device coupled to the host device, a fault event log, an error associated with a hard disk drive, an error associated with a power supply unit, or an error associated with a fan.

4. The host system of claim 1, wherein the characteristic of the visible light beam comprises at least one of a flashing frequency or a light intensity, and the flashing frequency is in a range between 0 Hz and 60 Hz.

5. The host system of claim 1, wherein the device controller is configured to:
receive an erase request from an external device coupled to the host device; and
erase, based on the erase request, the stored information.

6. The host system of claim 5, wherein the light controller is configured to:
based on the information stored in the host system, control the light emitting device to repeatedly emit the visible light beam with modulated characteristic; and
in response to determining that the information is erased, turn off the light emitting device.

7. The host system of claim 1, wherein the light controller is configured to, based on the information stored in the host system, control the light emitting device to repeatedly emit the visible light beam with modulated characteristic.

8. The host system of claim 1, wherein the device controller is configured to periodically receive the information indicating at least one status of the host system from at least one of:
one or more sensors;
the one or more processors; or
a PCIe switch.

9. The host system of claim 1, wherein each data packet of the at least one data packet comprises at least one separator, a frame header and at least one data payload, and wherein the frame header comprises data indicating a packet length.

10. The host system of claim 1, wherein the device controller is configured to transmit, to the light controller, the at least one data packet using at least one of a recommended standard 232 protocol or an inter-integrated circuit (I²C) communication protocol.

11. The host system of claim 1, wherein each data packet of the at least one data packet corresponds to one or more statuses of the at least one status of the host system.

12. The host system of claim 1, wherein the host system is configured to store a library, the library comprises a plurality of binary codes and data indicating a plurality of statuses, and each of the plurality of statuses corresponds to a respective one of the plurality of binary codes, and
wherein the device controller is configured to encode the information indicating the at least one status of the host system into the at least one data packet based on the library.

13. A method, comprising:
receiving, by a device controller, information indicating at least one status of a host system, the host system comprising a host device, the host device comprising one or more processors;
storing, by the host system, the information indicating at least one status of the host system;
encoding, by the device controller, the information indicating the at least one status of the host system into at least one data packet;
modulating, by a light controller coupled to the device controller and based on the at least one data packet, a current flowing through a light emitting device; and
emitting, by the light emitting device, a modulated visible light beam based on the modulated current.

14. The method of claim 13, wherein the modulated visible light beam is configured to be demodulated into at least one demodulated data packet for determination of at least one demodulated status of the host system, and the at least one demodulated status of the host system is configured to be displayed.

15. The method of claim 13, comprising:
controlling the light emitting device to repeatedly emit the modulated visible light beam based on the information stored in the host system;
receiving an erase request by the device controller from an external device that is configured to be coupled to the host device;
erasing, based on the erase request, the stored information in the host system; and
in response to determining that the information is erased from the device controller, turning off the light emitting device.

16. The method of claim 13, wherein emitting the modulated visible light beam comprises:
emitting the modulated visible light beam with a flashing frequency of a range between 0 Hz and 60 Hz.

17. The method of claim 13, wherein receiving the information indicating at least one status of the host system comprises:
periodically receiving the information indicating the at least one status of the host system from at least one of:
one or more sensors;
the one or more processors; or
a PCIe switch.

18. The method of claim 13, comprising:
transmitting, by the device controller, the at least one data packet to the light controller using at least one of a recommended standard 232 protocol or an inter-integrated circuit (I²C) communication protocol.

19. The method of claim 13, wherein each data packet of the at least one data packet corresponds to one or more statuses of the at least one status of the host system.

20. A device, comprising:
a device controller coupled to one or more processors, wherein the device controller comprises:
one or more sensors configured to measure one or more properties associated with a host system, wherein the host system comprises a host device, and the host device comprises one or more processors; and
at least one circuit configured to:
receive information indicating at least one status of the host system from at least one of (i) the one or more sensors, or (ii) the host device; and
generate, based on the information indicating the at least one status of the host system, at least one data packet;
a light controller coupled to the device controller; and
a light emitting device coupled to the light controller,
wherein the light controller is configured to modulate, based on the at least one data packet, a current flowing through the light emitting device to modulate a characteristic of a visible light beam, and the modulated characteristic of the visible light beam indicates the at least one status of the host system, and
wherein the light emitting device is configured to emit the visible light beam with modulated characteristic.
